(19) United States
(12) Patent Application Publication
(10) Pub. No.: US 2024/0387134 A1
(43) Pub. Date: Nov. 21, 2024

(54) CONTACT PIECE STRUCTURE AND MAGNETIC HOLDING RELAY

(71) Applicant: Xiamen Hongfa Electric Power Controls Co., Ltd., Xiamen (CN)

(72) Inventors: Guojin LIAO, Xiamen (CN); Wenguang DAI, Xiamen (CN); Shuming ZHONG, Xiamen (CN); Fangneng LI, Xiamen (CN)

(21) Appl. No.: 18/668,128

(22) Filed: May 17, 2024

(30) Foreign Application Priority Data
May 18, 2023 (CN) 202310565273X

(51) Int. Cl. H01H 50/54

(52) U.S. Cl. CPC H01H 50/54

(57) ABSTRACT

A contact piece structure includes a piece body having a slot. The slot has opposite first and second sidewalls. The first sidewall has a first plane portion and a protrusion, the second sidewall has a second plane portion and a recess recessed into the second plane portion and corresponding to the protrusion. A first distance from a top end of the protrusion of the first sidewall to a plane where the second plane portion is positioned is less than a thickness of the piece body.

### CROSS-REFERENCE TO RELATED APPLICATION(S)

This application is based upon and claims priority to Chinese Patent Application No. 202310565273.X, filed on May 18, 2023, the entire contents thereof are incorporated herein by reference.

### TECHNICAL FIELD

The present disclosure relates to the field of a relay, specifically to a contact piece structure and a magnetic holding relay.

### BACKGROUND

A magnetic holding relay is an automatic switch that plays a role of connecting and disconnecting circuits. The magnetic holding relay includes a movable contact part and a coil. The movable contact part has at least two contact pieces, in which movable contacts are provided on one of the contact pieces and static contacts are provided on the other of the contact pieces. When the coil is supplied with a forward pulse voltage, the movable contacts and the static contacts are connected, and the circuit is conducted; when the coil is supplied with a reverse pulse voltage, the movable contacts and the static contacts are disconnected, and the circuit is disconnected.

The movable contact part includes a movable contact piece and a pressure spring. In order to ensure stability of electrical performance, both the movable contact piece and the pressure spring are provided with slots, and a size of the slot is greater than a thickness of the movable contact piece or the pressure spring itself. As such, before the movable contact part is assembled, during transportation, the movable contact piece or the pressure spring may insert into the slots of other movable contact pieces or pressure springs, easily causing deformation of these parts, and it is also necessary to disassemble them before assembling, reducing production efficiency.

Those contents as disclosed in the Background portion are merely used to reinforce understanding of the background technology of the present disclosure, accordingly the Background portion may include information that does not constitute the related art as already known by an ordinary person skilled in the art.

### SUMMARY

The embodiments of the present disclosure provide a contact piece structure, including:
a piece body having a slot, the slot having opposite first and second sidewalls, the first sidewall having a first plane portion and a protrusion projecting from the first plane portion towards the second sidewall, the second sidewall having a second plane portion and a recess recessed into the second plane portion and corresponding to the protrusion; and a first distance from a top end of the protrusion of the first sidewall to a plane where the second plane portion is positioned being less than a thickness of the piece body.

In some embodiments of the present disclosure, a second distance between the first sidewall and the second sidewall is greater than or equal to the thickness of the piece body.

In some embodiments of the present disclosure, a distance between the first plane portion and the second plane portion is equal to or less than a distance between the protrusion of the first sidewall and the recess of the second sidewall.

In some embodiments of the present disclosure, a distance between the first plane portion and the second plane portion is greater than a distance between the protrusion of the first sidewall and the recess of the second sidewall.

In some embodiments of the present disclosure, the protrusion and the recesses are triangular, arch-shaped, square, rectangular, trapezoidal, U-shaped, or hexagonal, or any combination thereof.

In some embodiments of the present disclosure, the protrusions and recesses have the same shape.

In some embodiments of the present disclosure, the contact piece structure is a pressure spring, the piece body of the pressure spring is a first piece body, the first piece body has two connecting holes for connecting movable contacts;
wherein the slot includes a first slot provided at one end of the pressure spring having the connecting holes, and the first slot is located between the two connecting holes.

In some embodiments of the present disclosure, the contact piece structure is a movable contact piece; the piece body of the movable contact piece is a second piece body the second piece body has two first mounting holes at one end, for mounting movable contacts; the slot includes a second slot provided between the two first mounting holes.

In some embodiments of the present disclosure, the second piece body of the movable contact piece has two second mounting holes at the other end, for mounting static contacts; the second slot extends from the end of the second piece body at which the first mounting holes are provided to but not reaching the second mounting holes.

In some embodiments of the present disclosure, the contact piece structure comprises a plurality of movable contact pieces stacked with each other, each of the movable contact pieces is provided with the second slot, and the protrusions at the first sidewalls of the second slots of the movable contact pieces have the same or different shapes, and the recesses at the second sidewalls of the second slots of the movable contact pieces have the same or different shapes.

The embodiments of the present disclosure further provide a magnetic holding relay, including the contact piece structure according to the above embodiments.

### BRIEF DESCRIPTION OF THE DRAWINGS

The above-described and other features and advantages of the present disclosure will become more apparent from the detailed descriptions of exemplary embodiments with reference with the accompanying drawings.

FIG. 1 is a schematic view of a contact piece structure according to some embodiments of the present disclosure, wherein a shape of both protrusion and recesses is triangular.

FIG. 2 is a schematic view of the contact piece structure according to some embodiments of the present disclosure, wherein the shape of the protrusions is triangular, the recess corresponds to the protrusion, both of which are single.

FIG. 3 is a schematic view of a contact piece structure according to some other embodiments of the present disclosure, wherein a shape of both protrusion and recesses is arch-shaped.

FIG. 4 is a schematic view of the contact piece structure according to some other embodiments of the present disclosure, wherein the shape of both the protrusions and the recesses is square.

FIG. 5 is a schematic view of the contact piece structure according to some other embodiments of the present disclosure, wherein the shape of both the protrusions and the recesses is rectangular.

FIG. 6 is a schematic view of the contact piece structure according to some other embodiments of the present disclosure, wherein the shape of both the protrusions and the recesses is rectangular.

FIG. 7 is a schematic view of the contact piece structure according to some other embodiments of the present disclosure, wherein the shape of both the protrusions and the recesses is trapezoidal.

FIG. 8 is a schematic view of the contact piece structure according to some other embodiments of the present disclosure, wherein the shape of both the protrusions and the recesses is U-shaped.

FIG. 9 is a schematic view of the contact piece structure according to some other embodiments of the present disclosure, wherein the shape of both the protrusions and the recesses is regular hexagonal.

FIG. 10 is a schematic view of a contact piece structure according to some other embodiments of the present disclosure.

FIG. 11 is a schematic view of the contact piece structure according to some embodiments of the present disclosure, including a pressure spring and a movable contact piece.

FIG. 12 is a schematic view of a contact piece structure according to some embodiments of the present disclosure, including a pressure spring and a movable contact piece.

FIG. 13 is a schematic view of the contact piece structure according to some other embodiments of the present disclosure, showing a movable contact piece.

FIG. 14 is a schematic view of the contact piece structure according to some embodiments of the present disclosure, showing a pressure spring and a movable contact piece.

FIG. 15 is a schematic view of the contact piece structure according to some embodiments of the present disclosure, showing a pressure spring and a movable contact piece.

FIG. 16 is a perspective schematic view of a magnetic holding relay according to some embodiments of the present disclosure.

FIG. 17 is a perspective schematic view of the magnetic holding relay according to some embodiments of the present disclosure, without a cover.

the reference numerals are listed as follows:
1 piece body
2 slot
21 first sidewall
211. first plane portion
212. protrusion
22 second sidewall
221 second plane portion
222 recess
1′ first piece body
2′ first slot
3′ connecting hole
1″ second piece body
11″ first movable piece body
12″ second movable piece body
13″ third movable piece body
2″ second slot
3″ first mounting hole
4″ second mounting hole
5 housing
51 base
52 cover
d1 first distance
d2 second distance
d3 thickness of the piece body

### DETAILED DESCRIPTION

Now, the exemplary implementations will be described more completely with reference to the accompanying drawings. However, the exemplary implementations can be done in various forms and should not be construed as limiting the implementations as set forth herein. Instead, these implementations are provided so that the present disclosure will be thorough and complete, and concept of the exemplary implementation will be fully conveyed to those skilled in the art. Same reference numbers denote the same or similar structures in the figures, and thus the detailed description thereof will be omitted.

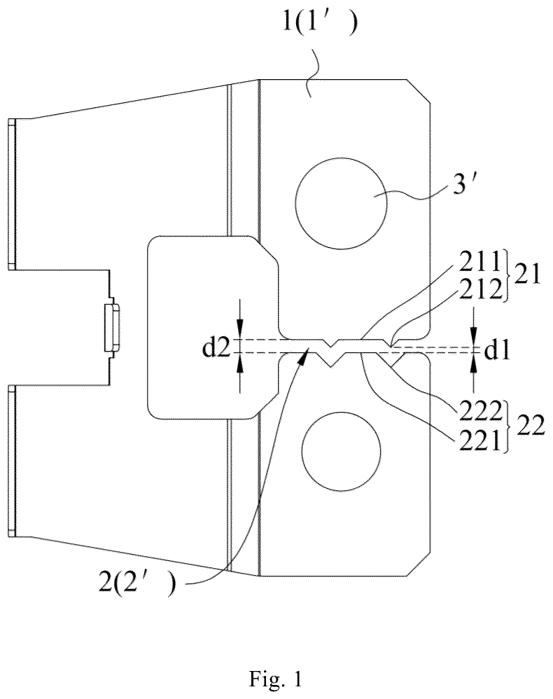

As shown in FIGS. 1 to 15, the embodiments of the present disclosure provide a contact piece structure, including a piece body 1. The piece body 1 has a slot 2 that has opposite first and second sidewalls 21 and 22. The first sidewall 21 has a first plane portion 211 and a protrusion 212 projecting from the first plane portion 211 towards the second sidewall 22. The second sidewall 22 has a second plane portion 221 and a recess 222 recessed into the second plane portion 221 and corresponding to the protrusion 212. A first distance d1 from a top end of the protrusion 212 on the first sidewall 21 to a plane where the second plane portion 221 is located is less than a thickness d3 of the piece body 1.

In the embodiments of the present disclosure, the first sidewall 21 of the slot 2 has a first plane portion 211 and a protrusion 212, the second sidewall 22 has a second plane portion 221 and a recess 222, and a first distance d1 from a top end of the protrusion 212 on the first sidewall 21 to a plane where the second plane portion 221 is located is less than a thickness d3 of the piece body 1. This can prevent other contact piece bodies 1 from being inserted into the slot 2 during transportation, thereby avoiding deformation of the contact piece structure. Additionally, there is no need to be disassembled before assembly, thus improving production efficiency.

The contact piece structure according to the embodiment of the present disclosure will be described in detail below.

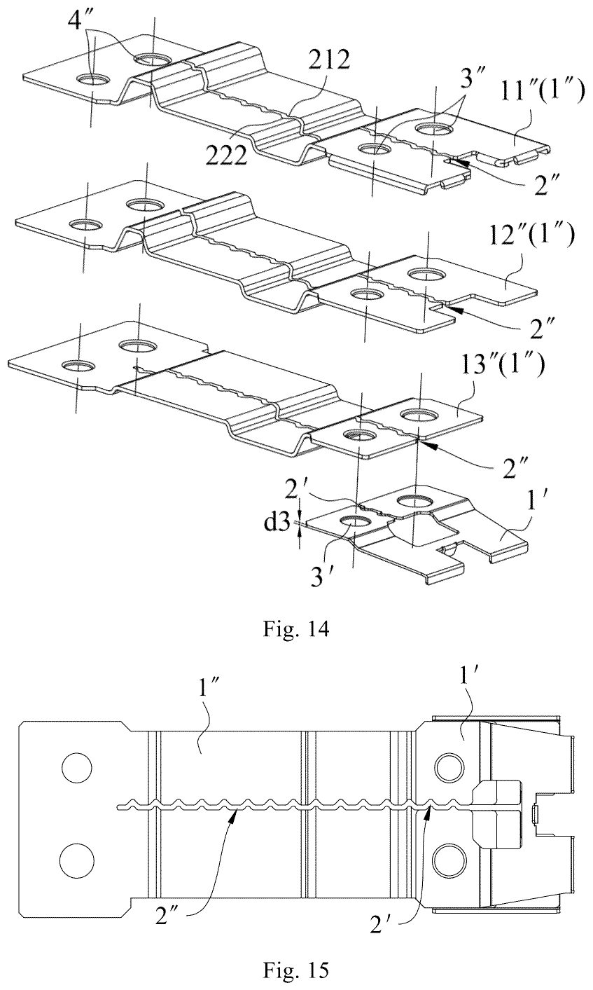

As shown in FIG. 14, a thickness d3 of the piece body 1 is a dimension of the piece body 1 in a direction perpendicular to the piece body 1. As shown in FIG. 1, both the first plane portion 211 and the second plane portion 221 are planar.

In some embodiments, a second distance d2 between the first sidewall 21 and the second sidewall 22 is greater than or equal to a thickness d3 of the piece body 1. Here, the second distance d2 between the first sidewall 21 and the second sidewall 22 may be a distance between the first plane portion 211 and the second plane portion 221, or a distance from a top end of the protrusion 212 to a bottom end of the recess 222, i.e., no matter it is the distance between the first plane portion 211 and the second plane portion 221, or the distance from the top end of the protrusion 212 to the bottom end of the recess 222, the distance is greater than or equal to the thickness d3 of the piece body 1.

That is to say, there is a non-linear gap formed between the first sidewall 21 and the second sidewall 22, a width of the gap is greater than or equal to the thickness d3 of the piece body 1. The second distance d2 between the first sidewall 21 and the second sidewall 22 is greater than or equal to the thickness d3 of the piece body 1. This can ensure strength of the piece body 1 when forming with a stamping die. That is, when the piece body 1 is stamped to form a gap between the first sidewall 21 and the second sidewall 22, if a second space d2 of the gap is smaller, especially less than the thickness d3 of the piece body 1, the strength of the piece body 1 during stamping is less, which can easily cause the piece body 1 to be broken. In the embodiments of the present disclosure embodiment, the second space d2 of the gap of the piece body 1 is set to be greater than or equal to the thickness d3 of the piece body 1, to increase the strength of the piece body 1 when being stamped, thereby less likely to be broken, being suitable for mass production. Here, a width of the gap may be understood as a dimension of the gap along a direction perpendicular to the first plane portion 211 and the second plane portion 221.

In some embodiments, the distance between the first plane portion 211 and the second plane portion 221 is equal to or less than the distance between the protrusion 212 of the first sidewall 21 and the recess 222 of the second sidewall 22.

In some embodiments, the distance between the first plane portion 211 and the second plane portion 221 is greater than the distance between the protrusion 212 of the first sidewall 21 and the recess 222 of the second sidewall 22.

Specifically, the distance between the first plane portion 211 and the second plane portion 221 may be adjusted corresponding to the distance between the protrusion 212 of the first sidewall 21 and the recess 222 of the second sidewall 22. That is, the width dimension of the gap formed by the first sidewall 21 and the second sidewall 22 may be the same or different, but the first distance d1 from the protrusion 212 of the first sidewall 21 to the plane where the second plane portion 221 of the second sidewall 22 is located is always less than the thickness d3 of the piece body 1. This can allow the protrusion 212 to act as a barrier against other contact piece bodies, preventing their insertion.

In some embodiments, the second distance d2 between the first sidewall 21 and the second sidewall 22 may be 1.5 to 4 times of the first distance d1 from the protrusion 212 of the first sidewall 21 to the second plane portion 221 of the second sidewall 22. Specifically, in addition to the above two end values, it may also be 2 times, 2.5, 3, 3.5 times, etc., without special limitation. In some embodiments, the first distance d1 from the protrusion 212 of the first sidewall 21 to the plane where the second plane portion 221 of the second sidewall 22 is located may be ¼, ⅓, ½ of the thickness d3 of the piece body 1, without special limitation. For example, the second distance d2 may be 0.5 mm, the first distance d1 may be 0.125 mm, and the thickness d3 of the piece body 1 may be 0.25 mm.

Regarding the distance between the first plane portion 211 and the second plane portion 221 and the distance between the protrusion 212 of the first sidewall 21 and the recess 222 of the second sidewall 22, it may be adjusted according to the actual situations, without special limitation. Here, the distance between the protrusion 212 and the recess 222 may be understood as the distance from the top end of the protrusion 212 to the bottom end of the recess 222.

In some embodiments, as shown in FIGS. 1 to 10, the shape of the protrusion 212 and the recess 222 may be triangular, arch-shaped, square, rectangular, trapezoidal, and hexagonal, or any combination thereof.

In some embodiments, as shown in FIGS. 1 to 9, the shapes of the protrusion 212 and the recess 222 are the same.

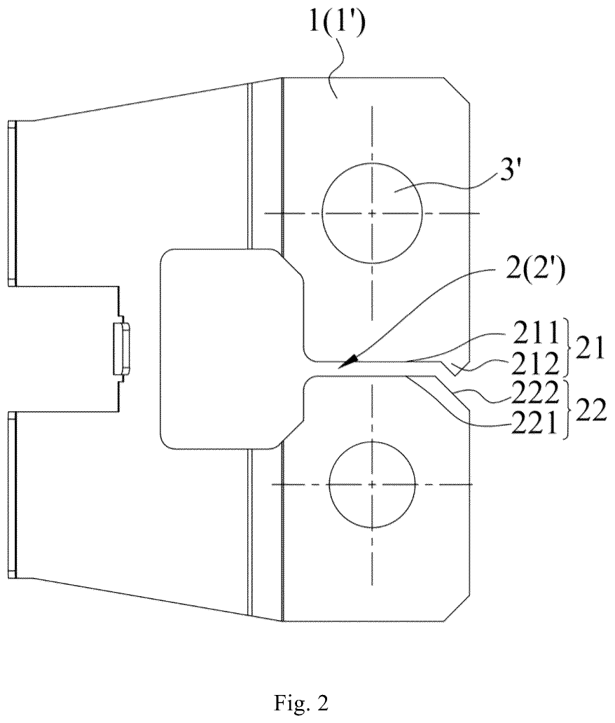

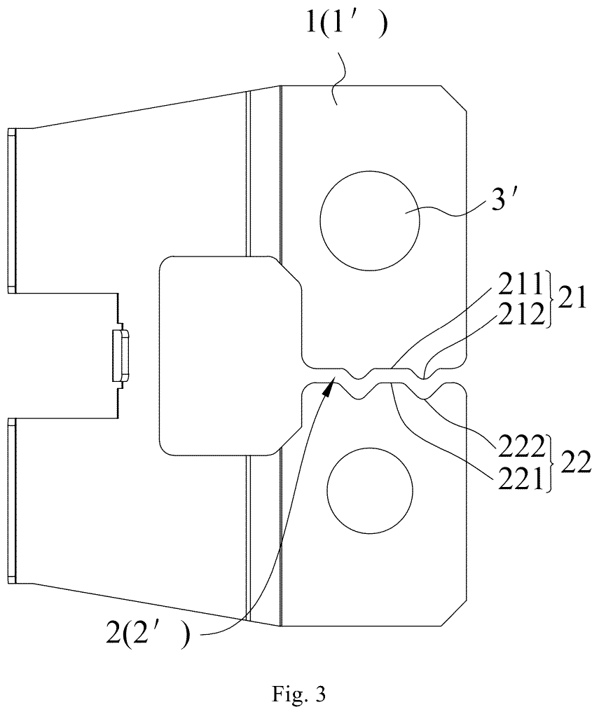

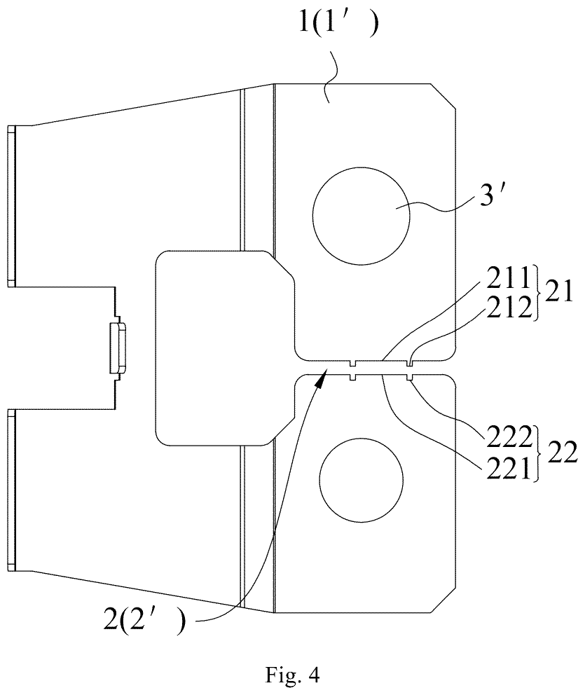

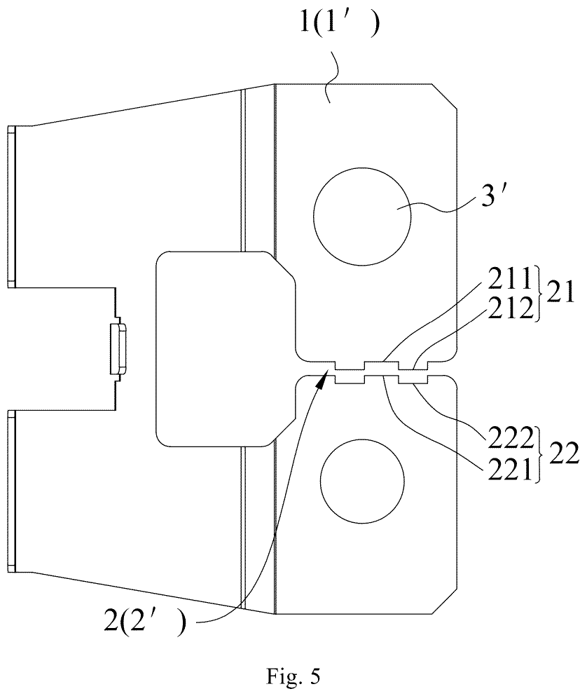

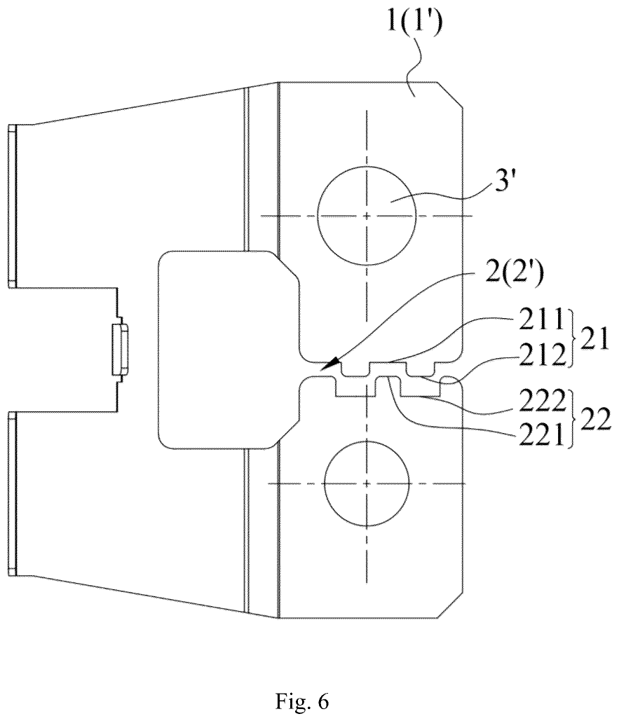

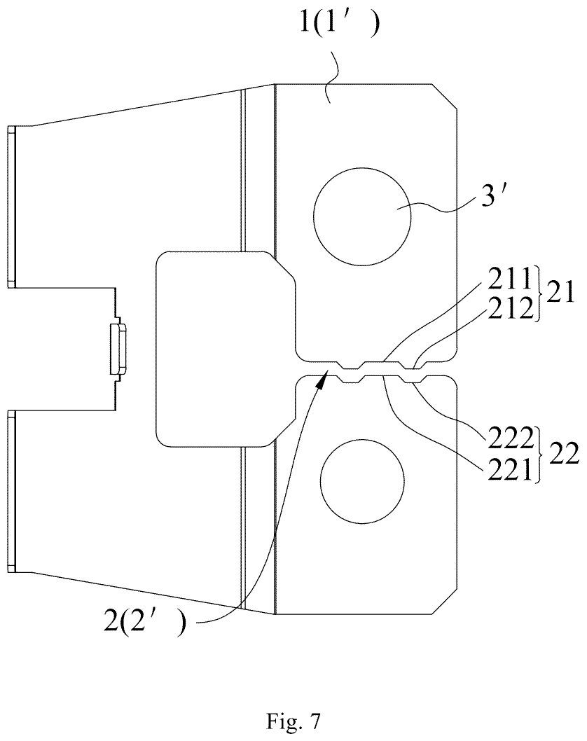

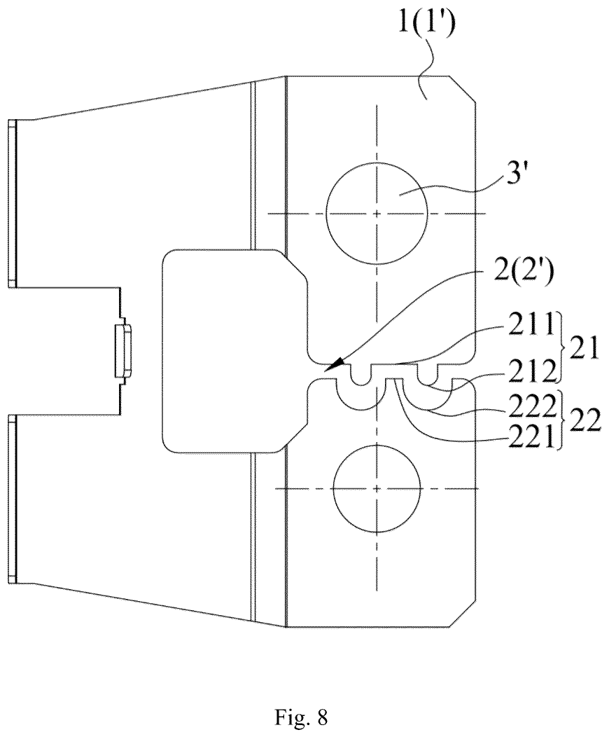

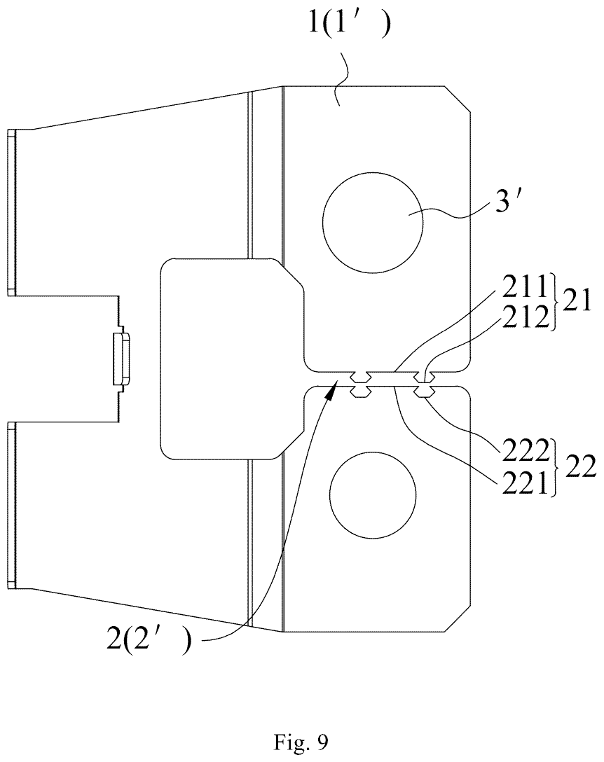

As shown in FIGS. 1 and 2, the shapes of the protrusion 212 and the recesses 222 are both triangular. Here, the shape of the protrusion 212 and the recess 222 may be understood as a shape of a graph formed by edge contour lines of the protrusion 212 and the recess 222. In FIG. 1, it is shown that the number of the protrusion 212 and the recess 222 may be in plural. In FIG. 2, it is shown that the number of each of the protrusion 212 and the recess 222 is single (one), and the protrusion 212 and the recess 222 are located at an edge of the slot 2. As shown in FIG. 3, the shapes of both the protrusion 212 and the recess 222 are arch-shaped. As shown in FIG. 4, the shapes of both the protrusion 212 and the recess 222 are square. As shown in FIGS. 5 and 6, the shapes of both the protrusion 212 and the recess 222 are rectangular. In FIG. 6, the size of the protrusion 212 is smaller than that of the recess 222. As shown in FIG. 7, the shapes of both the protrusion 212 and the recesses 222 are trapezoidal. As shown in FIG. 8, the shapes of both the protrusion 212 and the recess 222 are U-shaped. As shown in FIG. 9, the shapes of both the protrusion 212 and the recess 222 are regular hexagonal, of course, the shapes of both the protrusion 212 and the recess 222 may also be pentagonal, octagonal, etc., without special limitation. The protrusion 212 and the recess 222 have the same shape in order to adjust the distance between the protrusion 212 and the recess 222 and facilitate processing, thereby improving processing efficiency.

In some other embodiments, the shapes of the protrusion 212 and the recess 222 may also be different. For example, the shape of the protrusion 212 is triangular, and correspondingly, the shape of the recess 222 is arch-shaped; the shape of the protrusion 212 is trapezoidal, and correspondingly, the shape of the recess 222 may be rectangular. It may be adjusted by the person skilled in the art according to the actual situations, without special limitation.

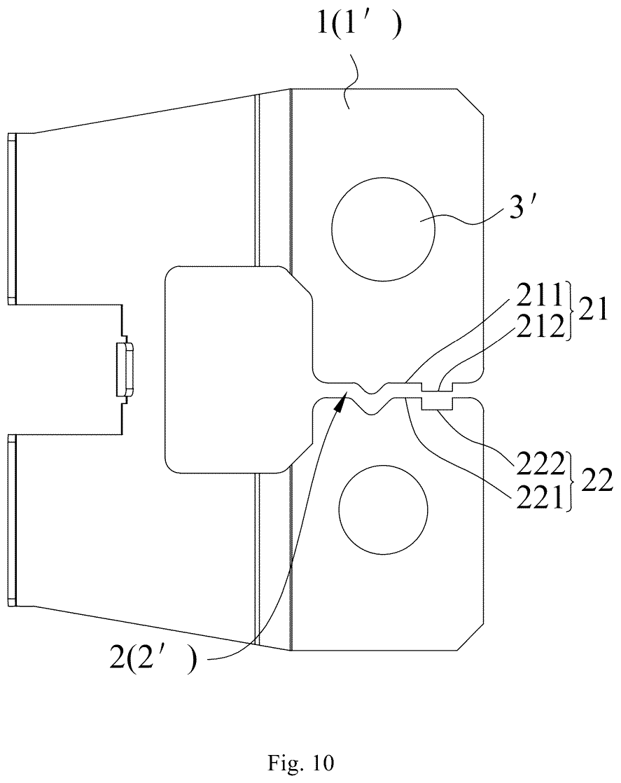

In some other embodiments, as shown in FIG. 10, the shapes of a plurality of the protrusions 212 on the first sidewall 21 may also be different, and the shapes of a plurality of the recesses 222 on the second sidewall 22 may also be different. For example, the first protrusion 212 on the first sidewall 21 is arch-shaped, the second protrusion 212 thereof is rectangular, and the recess 222 corresponding to the first protrusion 212 may be arch-shaped, trapezoidal, or rectangular, and the recess 222 corresponding to the second protrusion 212 may be rectangular, triangular, or square. That is, among the plurality of protrusions 212, the shape of the protrusion 212 and the shapes of other protrusions 212 may be different, and the shape of the recess 222 corresponding to the protrusion 212 may be the same or different, which can be set according to the actual situation by persons skilled in the art, without special limitation.

In some embodiments, as shown in FIGS. 1 to 12, the contact piece structure includes a pressure spring, the pressure spring includes the piece body 1 mentioned in the above embodiments. For ease of distinction, the piece body 1 is referred to as a first piece body 1′, and the first piece body 1′ has two connecting holes 3′ for mounting movable contacts. Here, the slot 2 includes a first slot 2′, the first slot 2′ is provided at one end of the first piece body 1′ having the connecting holes 3′ of the pressure spring, and the first slot 2′ is located between the two connecting holes 3′.

The pressure spring is used to connect the movable contact and a pushing part of the relay. When the pushing part moves, the first piece body 1′ of the pressure spring moves together to drive the movement of the movable contact, thereby achieving the connection or disconnection of the movable contact and the static contact. Therefore, the two connecting holes 3′ of the first piece body 1′ of the pressure spring are used to connect the movable contact. The first slot 2′ is provided between the two connecting holes 3′, which can reduce stress on the first piece body 1′ and improve service life of the pressure spring. In addition, the first slot 2′ of the first piece body 1′ of the pressure spring has a protrusion 212 projecting towards the second sidewall 22 on the first sidewall 21, and the recess 222 corresponding to the protrusion 212 on the second sidewall 22. This configuration can increase a heat dissipation area of the pressure spring and improve the heat dissipation efficiency of the pressure spring.

In some embodiments, as shown in FIG. 13, the contact piece structure includes a movable contact piece, the movable contact piece includes the piece body 1 mentioned in the above embodiments, referred to as the second piece body 1″ here. The second piece body 1″ of the movable contact piece has two first mounting holes 3″ at one end, the first mounting holes 3″ are used for mounting the movable contacts. The slot 2 includes a second slot 2″ that is provided between the two first mounting holes 3″.

In some embodiments, as shown in FIG. 13, the second piece body 1″ of the movable contact piece has two second mounting holes 4″ at the other end, the second mounting holes 4″ are used for mounting the static contacts. The second slot 2″ extends from the end of the second piece body 1″ having the first mounting holes 3″ of the movable contact piece towards a direction closing to but not reaching the second mounting holes 4″.

Specifically, as shown in FIGS. 13 and 14, the second piece body 1″ of the movable contact piece has two ends opposite to each other respectively provided with a first mounting hole 3″ and a second mounting hole 4″, for mounting the movable contact and the static contact. The second slot 2″ is provided between the two mounting holes, which can reduce the stress on the movable contact piece and improve the service life of the movable contact piece. At the same time, the first side wall 21 of the second slot 2″ has the protrusion 212, and the second side wall 22 has the recess 222, which can increase an effective length of the second piece body 1″ of the movable contact piece. When the movable contact piece is assembled with the movable contact and the static contact and energized, the increased effective length can increase an ampere-force (the movable contact piece, after being assembled and energized, may form a parallel circuit structure with other movable contact pieces, and the two parallel movable contact pieces may attract each other with the ampere-force) applied to the movable contact piece, thus increasing the contact pressure between the movable contact and the static contact, and improving the stability of the contact of the movable contact and the static contact.

In some embodiments, as shown in FIG. 14, the contact piece structure includes a plurality of stacked movable contact pieces, and the second piece body 1″ of each of the movable contact pieces is provided with a second slot 2″. The shapes of the protrusions 212 on the first side walls 21 of the second slots 2″ of the movable contact pieces are the same or different, and the shapes of the recesses 222 on the second side walls 22 of the second slots 2″ of the movable contact pieces are the same or different.

In some embodiments, as shown in FIG. 14, the contact piece structure includes three movable contact pieces, and the shapes of the protrusions 212 and the recesses 222 of the second contact piece bodies 1″ of the three movable contact pieces are the same, for example, being arch-shaped. The second contact piece bodies 1″ of the three movable contact pieces are respectively the first movable piece body 11″, the second movable piece body 12″, and the third movable piece body 13″. In some other embodiments, on the first sidewall 21 of the second slot 2″ of the first movable piece body 11″, the protrusion 212 may be triangular, and the recess 222 may be triangular. On the first side wall 21 of the second slot 2″ of the second movable piece body 12″, the protrusion 212 may be arch-shaped and the recess 222 may be arch-shaped. On the first sidewall 21 of the second slot 2″ of the third movable contact body 13″, the protrusion 212 may be trapezoidal, and the recess 222 may be trapezoidal. Of course, the protrusions and the recesses of the movable contact pieces may have different shapes, and there are no special limitations here.

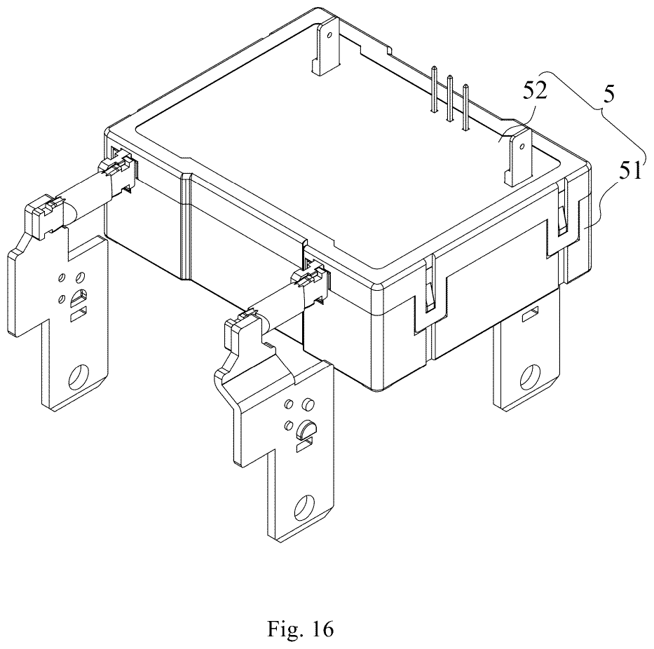

In some embodiments, as shown in FIGS. 14 and 15, the contact piece structure includes a pressure spring and a movable contact piece. The first slot 2′ of the first piece body 1′ of the pressure spring is configured the same as the second slot 2″ of the second piece body 1″ of the movable contact piece, as described in the above embodiments, and will not be repeated here.

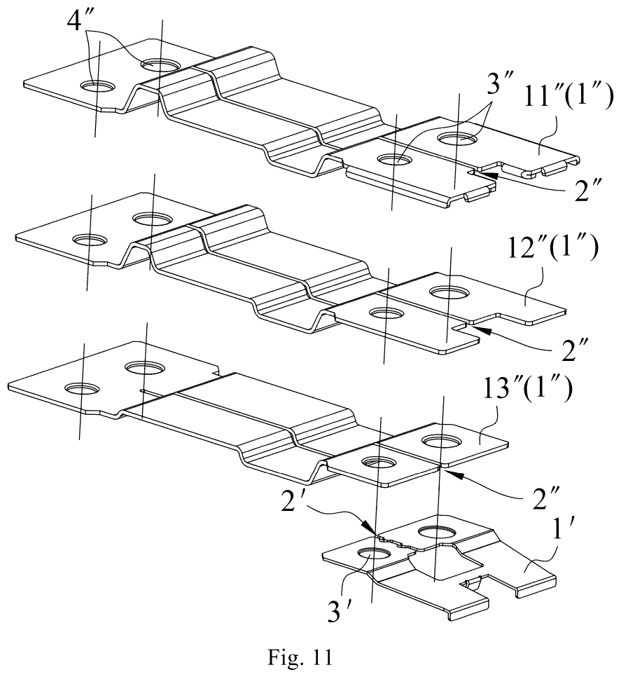

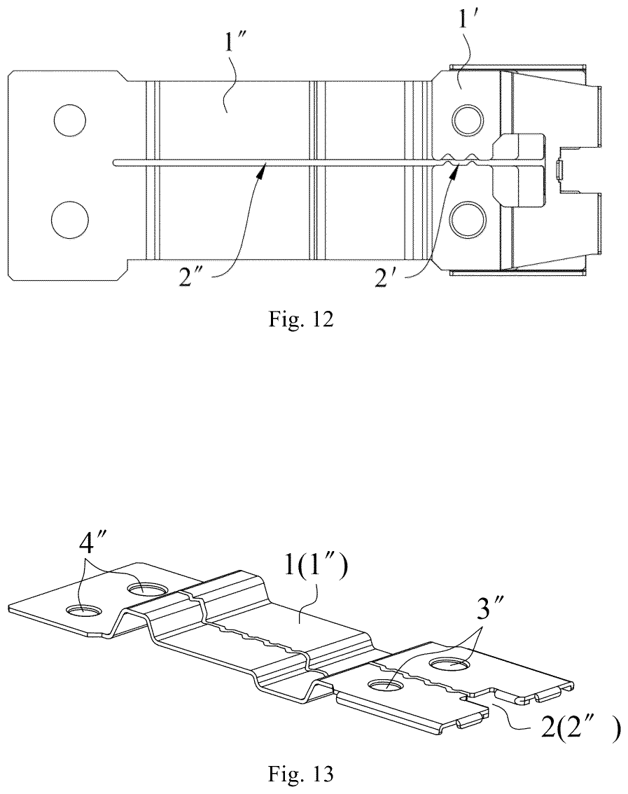

In some other embodiments, as shown in FIGS. 11 and 12, there is no protrusion 212 provided on the first sidewall 21 of the second slot 2″ of the second piece body 1″ of the movable contact piece, and there is no recess 222 on the second side wall 22 thereof. Both the first sidewall 21 and the second sidewall 22 are planar. This movable contact piece, when assembled with the pressure spring mentioned above, forms the contact piece structure in the above embodiments.

In some embodiments, the contact piece structure may also include movable contacts and static contacts (not shown). The connecting holes 3′ of the first piece body 1′ of the pressure spring, and the first mounting holes 3″ of the second piece body 1″ of the movable contact piece are assembled with the movable contacts, and the second mounting holes 4″ of the second piece body 1″ of the movable contact piece are assembled with the static contacts, which can be formed into a movable contact assembly in a relay.

As above described, the first sidewall 21 of the slot 2 in the embodiment of the present disclosure has the first plane portion 211 and the protrusion 212, and the second sidewall 22 has the second plane portion 221 and the recess 222. The first distance d1 from the top end of the protrusion 212 on the first sidewall 21 to the plane where the second plane portion 221 is located is less than the thickness d3 of the piece body 1. This can prevent other contact piece bodies 1 from being inserted into the slot 2 during transportation, thereby avoiding the deformation of the contact piece structure. In addition, there is no need to be disassembled before assembly, thus improving the production efficiency.

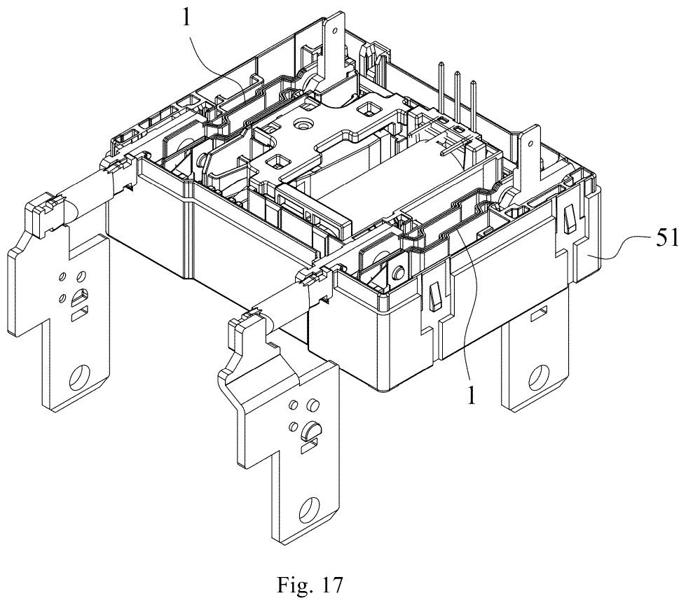

The embodiment of the present disclosure also provides a magnetic holding relay, as shown in FIGS. 16 and 17, the magnetic holding relay includes a housing and a contact piece structure. The contact piece structure may include a pressure spring and a movable contact piece. The pressure spring and/or the movable contact piece may be the contact piece structure as described in any of the above embodiments.

Wherein, the housing 5 includes a base 51 and a cover 52. The contact piece structure is mounted on the base 51 and covered with the cover 52, allowing the contact piece structure to be accommodated within the housing 5. Since the contact piece structure has already been specifically described in the above embodiments, it will not be repeated here.

To sum up, the magnetic holding relay of the embodiment of the present invention includes the contact piece structure described in any of the above embodiments, and the contact piece structure is not easy to deform, and the production efficiency of the magnetic holding relay is improved.

It can be understood that the various examples/embodiments provided by the present disclosure can be combined with each other without contradiction, and detailed examples are not provided herein.

In the embodiments of the present disclosure, the terms “first”, “second”, “third” are used for descriptive purposes only and should not be understood as indicating or implying relative importance; the term “a plurality of” refers to two or more, unless there is a clear definition otherwise. The terms such as “installation”, “connected”, “connection”, “fixed” should be understood in a broad sense. For example, “connection” can be a fixed connection, or a removable connection, or an integral connection; “connected” can be directly connected, or indirectly connected through an intermediary medium. For the ordinary skilled person in the art, the specific meanings of these terms in the embodiments of the disclosure can be understood based on the specific circumstances.

In the description of the embodiments of the present disclosure, it should be understood that the terms “upper”, “lower”, “left”, “right”, “front”, and “rear” indicate a direction or position based on the orientation or position shown in the accompanying drawings. These terms are used only to facilitate the description of the embodiment and to simplify the description, and are not intended to indicate or imply that the device or unit referred to must have a specific direction, be constructed and operated in a specific orientation. Therefore, these terms should not be construed as limiting the embodiments of the disclosure.

In the description of this specification, terms such as “an embodiment,” “some embodiments,” “a specific embodiment” refer to the specific features, structures, materials, or characteristics described in conjunction with the embodiment or example being included in at least one embodiment or example of the disclosure. In this specification, the illustrative terms do not necessarily refer to the same embodiment or example. Moreover, the specific features, structures, materials, or characteristics described may be suitably combined in any one or more of the embodiments or examples.

The above description is merely a preferred embodiment of the present disclosure and is not intended to limit the embodiment. For the person skilled in the art, the present disclosure may be subject to various changes and modifications. Any modifications, equivalent substitutions, improvements, and the like made within the spirit and principles of the embodiments of the present disclosure should be included within the scope of protection of the embodiments of the present disclosure.

We claim:

1. A contact piece structure, comprising:
a piece body having a slot, the slot having a first side wall and a second side wall opposite to the first side wall, the first sidewall having a first plane portion and a protrusion projecting from the first plane portion towards the second sidewall, the second sidewall having a second plane portion and a recess recessed into the second plane portion and corresponding to the protrusion;
a first distance from a top end of the protrusion of the first sidewall to a plane where the second plane portion is positioned being less than a thickness of the piece body.

2. The contact piece structure according to claim 1, wherein a second distance between the first sidewall and the second sidewall is greater than or equal to the thickness of the piece body.

3. The contact piece structure according to claim 1, wherein a distance between the first plane portion and the second plane portion is equal to or less than a distance between the protrusion of the first sidewall and the recess of the second sidewall.

4. The contact piece structure according to claim 1, wherein a distance between the first plane portion and the second plane portion is greater than a distance between the protrusion of the first sidewall and the recess of the second sidewall.

5. The contact piece structure according to claim 1, wherein shapes of the protrusion and the recess are triangular, arch-shaped, square, rectangular, trapezoidal, U-shaped, or hexagonal, or any combination thereof.

6. The contact piece structure according to claim 1, wherein the shapes of the protrusion and the recesses are the same.

7. The contact piece structure according to claim 1, wherein the contact piece structure is a pressure spring, the piece body of the pressure spring is a first piece body, the first piece body has two connecting holes for connecting movable contacts;
wherein the slot includes a first slot provided at one end of the pressure spring having the connecting holes, and the first slot is located between the two connecting holes.

8. The contact piece structure according to claim 2, wherein the contact piece structure is a pressure spring, the piece body of the pressure spring is a first piece body, the first piece body has two connecting holes for connecting movable contacts;
wherein the slot includes a first slot provided at one end of the pressure spring having the connecting holes, and the first slot is located between the two connecting holes.

9. The contact piece structure according to claim 3, wherein the contact piece structure is a pressure spring, the piece body of the pressure spring is a first piece body, the first piece body has two connecting holes for connecting movable contacts;
wherein the slot includes a first slot provided at one end of the pressure spring having the connecting holes, and the first slot is located between the two connecting holes.

10. The contact piece structure according to claim 4, wherein the contact piece structure is a pressure spring, the piece body of the pressure spring is a first piece body, the first piece body has two connecting holes for connecting movable contacts;
wherein the slot includes a first slot provided at one end of the pressure spring having the connecting holes, and the first slot is located between the two connecting holes.

11. The contact piece structure according to claim 5, wherein the contact piece structure is a pressure spring, the piece body of the pressure spring is a first piece body, the first piece body has two connecting holes for connecting movable contacts;
wherein the slot includes a first slot provided at one end of the pressure spring having the connecting holes, and the first slot is located between the two connecting holes.

12. The contact piece structure according to claim 6, wherein the contact piece structure is a pressure spring, the piece body of the pressure spring is a first piece body, the first piece body has two connecting holes for connecting movable contacts;
wherein the slot includes a first slot provided at one end of the pressure spring having the connecting holes, and the first slot is located between the two connecting holes.

13. The contact piece structure according to claim 1, wherein the contact piece structure is a movable contact piece; the piece body of the movable contact piece is a second piece body; the second piece body has two first mounting holes at one end, for mounting movable contacts; the slot includes a second slot provided between the two first mounting holes.

14. The contact piece structure according to claim 13, wherein the second piece body of the movable contact piece has two second mounting holes at the other end, for mounting static contacts; the second slot extends from the end of the second piece body at which the first mounting holes are provided to the second mounting holes but not reaching the second mounting holes.

15. The contact piece structure according to claim 13, wherein the contact piece structure comprises a plurality of movable contact pieces stacked with each other, each of the movable contact pieces is provided with the second slot, and the protrusions at the first sidewalls of the second slots of the movable contact pieces have the same or different shapes, and the recesses at the second sidewalls of the second slots of the movable contact pieces have the same or different shapes.

16. A magnetic holding relay, comprising a contact piece structure, wherein the contact piece structure comprises:
a piece body having a slot, the slot having a first side wall and a second side wall opposite to the first side wall, the first sidewall having a first plane portion and a protrusion projecting from the first plane portion towards the second sidewall, the second sidewall having a second plane portion and a recess recessed into the second plane portion and corresponding to the protrusion;
a first distance from a top end of the protrusion of the first sidewall to a plane where the second plane portion is positioned being less than a thickness of the piece body.

17. The magnetic holding relay according to claim 16, wherein the contact piece structure is a pressure spring, the piece body of the pressure spring is a first piece body, the first piece body has two connecting holes for connecting movable contacts;
wherein the slot includes a first slot provided at one end of the pressure spring having the connecting holes, and the first slot is located between the two connecting holes.

18. The magnetic holding relay according to claim 16, wherein the contact piece structure is a movable contact piece; the piece body of the movable contact piece is a second piece body; the second piece body has two first mounting holes at one end, for mounting movable contacts; the slot includes a second slot provided between the two first mounting holes.
